(19) United States
(12) Patent Application Publication
(10) Pub. No.: US 2023/0287581 A1
(43) Pub. Date: Sep. 14, 2023

(54) CARBON DIOXIDE TREATMENT APPRATUS, CARBON DIOXIDE TREATMENT METHOD, AND METHOD OF PRODUCING ETHYLENE

(71) Applicant: HONDA MOTOR CO., LTD., Tokyo (JP)

(72) Inventor: Hiroshi OIKAWA, Saitama (JP)

(21) Appl. No.: 18/173,078

(22) Filed: Feb. 23, 2023

(30) Foreign Application Priority Data
Mar. 11, 2022 (JP) 2022-038104

(51) Int. Cl. C25B 3/26; C25B 3/03; C25B 1/23; C25B 9/70; C25B 15/08; C25B 9/19; B01D 53/32; B01D 53/62; B01D 53/78

(52) U.S. Cl. CPC C25B 3/26; C25B 3/03; C25B 1/23; C25B 9/70; C25B 15/081; C25B 9/19; B01D 53/326; B01D 53/62; B01D 53/78; B01D 2251/604; B01D 2251/306; B01D 2258/06; B01D 2258/01; B01D 2257/504

(57) ABSTRACT

A carbon dioxide treatment apparatus includes: a capturing device that captures carbon dioxide; and an electrochemical reaction device that electrochemically reduces the carbon dioxide captured by the capturing device, and the electrochemical reaction device includes a first electrolytic cell that electrochemically reduces the carbon dioxide to carbon monoxide, and a second electrolytic cell that electrochemically reduces the carbon monoxide produced by the first electrolytic cell to ethylene.

This application is based on and claims the benefit of priority from Japanese Patent Application No. 2022-038104, filed on 11 Mar. 2022, the content of which is incorporated herein by reference.

### BACKGROUND OF THE INVENTION

### Field of the Invention

The present invention relates to a carbon dioxide treatment apparatus, a carbon dioxide treatment method, and a method of producing ethylene.

### Related Art

Conventionally, there is known a technique of capturing carbon dioxide in an exhaust gas or an atmosphere, electrochemically reducing the carbon dioxide, and obtaining valuables. This technique is a promising technique that can achieve carbon neutral, but the economic efficiency thereof is its biggest issue. In order to improve economic efficiency, it is important to improve energy efficiency and reduce carbon dioxide loss in carbon dioxide capture and reduction.

As a technique of capturing carbon dioxide, there is known a technique in which carbon dioxide in a gas is physically or chemically adsorbed on a solid or liquid adsorbent and then desorbed by energy such as heat. Furthermore, as the technology for electrochemically reducing carbon dioxide, a technology including using a cathode where a catalyst layer is formed using a carbon dioxide reduction catalyst on the side of a gas diffusion layer to be in contact with an electrolytic solution is used is known: in the technology, carbon dioxide gas is supplied to the cathode from the side opposite to the catalyst layer of the gas diffusion layer and carbon dioxide is electrochemically reduced (see for example, Patent Document 1).

Conventionally, a technique of capturing carbon dioxide and a technique of electrochemically reducing carbon dioxide are separately studied and developed. Hence, while total energy efficiency and a loss reduction effect of carbon dioxide in a case where the respective techniques are combined can be determined in a multiplier manner based on efficiency of each technique, there is still room for improvement. Thus, from a comprehensive standpoint of a combination of the technique of capturing carbon dioxide and the technique of electrochemically reducing carbon dioxide, it is significant to increase energy efficiency and a loss reduction effect of carbon dioxide.
Patent Document 1: PCT International Publication No. WO2018/232515

### SUMMARY OF THE INVENTION

By the way, a technique of electrochemically reducing carbon dioxide has a problem that, while an electrolytic solution becomes weakly alkaline when carbon dioxide supplied to a cathode side dissolves in the electrolytic solution, a reduction reaction under the weak alkali hardly proceeds, and therefore generation efficiency of ethylene of interest is poor. Hence, a technique capable of more selectively and efficiently producing ethylene that is a target product is desired.

The present invention has been made in light of the above, and an object of the present invention is to provide a technique capable of more selectively and efficiently producing ethylene in a carbon dioxide treatment apparatus that captures and electrochemically reduces carbon dioxide.
(1) The present invention relates to a carbon dioxide treatment apparatus (e.g., a carbon dioxide treatment apparatus 100 described later) that includes: a capturing device (e.g., a capturing device 1 described later) that captures carbon dioxide; and an electrochemical reaction device (e.g., an electrochemical reaction device 2 described later) that electrochemically reduces the carbon dioxide captured by the capturing device, the electrochemical reaction device including: a first electrolytic cell (e.g., a first electrolytic cell 21 described later) that electrochemically reduces the carbon dioxide to carbon monoxide; and a second electrolytic cell (e.g., a second electrolytic cell 22 described later) that electrochemically reduces the carbon monoxide produced by the first electrolytic cell to ethylene.

According to the carbon dioxide treatment apparatus according to (1), the first electrolytic cell electrochemically reduces the carbon dioxide to carbon monoxide, and the second electrolytic cell electrochemically reduces the carbon monoxide produced by the first electrolytic cell to ethylene. That is, in the first electrolytic cell in which carbon dioxide supplied dissolves and an electrolytic solution becomes weakly alkaline, generation of carbon monoxide is intentionally targeted. Furthermore, carbon monoxide does not dissolve in the electrolytic solution, the electrolytic solution does not become weakly alkaline, and therefore the carbon monoxide produced by the first electrolytic cell is supplied to the second electrolytic cell. Consequently, it is possible to promote an electrochemical reduction reaction of carbon monoxide while preventing the electrolytic solution from becoming weakly alkaline in the second electrolytic cell, so that the carbon dioxide treatment apparatus according to (1) can selectively and efficiently generate ethylene.
(2) In the carbon dioxide treatment apparatus according to (1), the electrochemical reaction device may further include a carbon monoxide supply path (e.g., a carbon monoxide supply path 20 described later) that is provided between the first electrolytic cell and the second electrolytic cell, and supplies the carbon monoxide produced by the first electrolytic cell to the second electrolytic cell.
(3) In the carbon dioxide treatment apparatus according to (2), the capturing device may include a carbon dioxide absorption unit (e.g., a CO₂ absorption unit 12 described later) that dissolves and absorbs carbon dioxide in a strongly alkaline electrolytic solution, and the carbon dioxide dissolved in the electrolytic solution in the carbon dioxide absorption unit may be supplied to the electrochemical reaction device.
(4) In the carbon dioxide treatment apparatus according to (3), the first electrolytic cell may include a cathode (e.g., a cathode 211 described later), an anode (e.g., an anode 212 described later), an electrolytic membrane (e.g., an anion exchange membrane 213 described later) that is provided between the cathode and the anode, a cathode side liquid flow path (e.g., a cathode side liquid flow path 214a described later) that is provided adjacent to the cathode, and in which the electrolytic solution with the carbon dioxide dissolved therein flows, and an anode side liquid flow path (e.g., an anode side liquid flow path 216a described later) that is provided adjacent to the anode, and in which the electrolytic solution flows; the second electrolytic cell may include a cathode (e.g., a cathode 221 described later), an anode (e.g., an anode 222 described later), an electrolytic membrane (e.g., an anion exchange membrane 223 described later) that is provided between the cathode and the anode, a cathode side gas flow path (e.g., a cathode side gas flow path 224a described later) that is provided adjacent to the cathode, and in which a gas flows, and a cathode side liquid flow path (e.g., a cathode side liquid flow path 225a described later) that is provided adjacent to the cathode, and in which the electrolytic solution flows, an anode side liquid flow path (e.g., an anode side liquid flow path 226a described later) that is provided adjacent to the anode, and in which the electrolytic solution flows; and the carbon monoxide supply path may be provided to connect an outlet of the cathode side liquid flow path of the first electrolytic cell, and an inlet of the cathode side gas flow path of the second electrolytic cell.
(5) The carbon dioxide treatment apparatus according to any one of (1) to (4) may further include a homologation reaction device (e.g., a homologation reaction device 4 described later) that multimerizes and homologates the ethylene produced by reducing the carbon dioxide by the electrochemical reaction device.
(6) Furthermore, the present invention relates to a carbon dioxide treatment method of electrochemically reducing carbon dioxide including: a first step (e.g., a first reducing step described later) of electrochemically reducing the carbon dioxide to carbon monoxide by a first electrolytic cell; and a second step (e.g., a second reducing step described later) of electrochemically reducing the carbon monoxide produced in the first step to ethylene by a second electrolytic cell.
(7) Furthermore, the present invention relates to an ethylene producing method including reducing carbon dioxide and producing ethylene by the carbon dioxide treatment method according to (6).

According to the present invention, it is possible to more selectively and efficiently generate ethylene in a carbon dioxide treatment apparatus that captures and electrochemically reduces carbon dioxide.

### BRIEF DESCRIPTION OF THE DRAWINGS

FIG. 1 is a block diagram illustrating a carbon dioxide treatment apparatus according to an embodiment of the present invention;

FIG. 2 is a schematic cross-sectional view illustrating an example of an electrolytic cell of an electrochemical reaction device;

FIG. 3A is a view illustrating a nickel-metal hydride battery of an electrical energy storage at a time of discharging; and

FIG. 3B is a view illustrating the nickel-metal hydride battery of the electrical energy storage at a time of charging.

### DETAILED DESCRIPTION OF THE INVENTION

An embodiment of the present invention will be described in detail below with reference to the drawings.

### [Carbon Dioxide Treatment Apparatus]

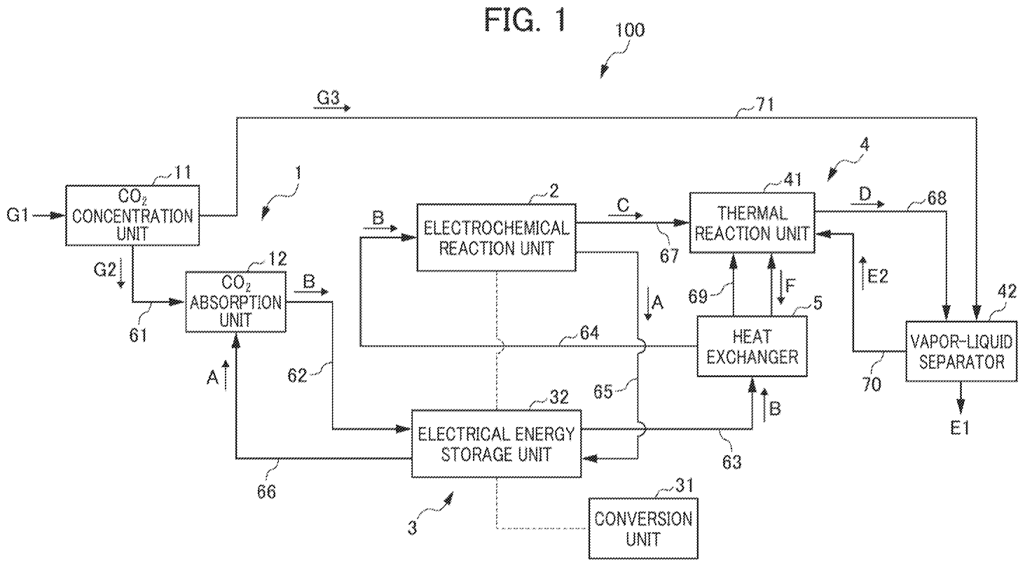

FIG. 1 is a block diagram illustrating a carbon dioxide treatment apparatus 100 according to an embodiment of the present invention. As illustrated in FIG. 1, the carbon dioxide treatment apparatus 100 according to the present embodiment includes a capturing device 1, an electrochemical reaction device 2, an electrical energy storage device 3, a homologation reaction device 4, and a thermal exchanger 5. The capturing device 1 includes a CO₂ concentration unit 11 and a CO₂ absorption unit 12. The electrochemical reaction device 2 includes an electrolytic cell. The electrical energy storage device 3 includes a converter 31 and an electrical energy storage 32. The homologation reaction device 4 includes a thermal reactor 41 and a vapor-liquid separator 42.

In the carbon dioxide treatment apparatus 100, the CO₂ concentration unit 11 and the CO₂ absorption unit 12 are connected by a gas flow path 61. The CO₂ absorption unit 12 and the electrical energy storage 32 are connected by a liquid flow path 62 and a liquid flow path 66. The electrical energy storage 32 and the thermal exchanger 5 are connected by a liquid flow path 63. The thermal exchanger 5 and the electrochemical reaction device 2 are connected by a liquid flow path 64. The electrochemical reaction device 2 and the electrical energy storage 32 are connected by a liquid flow path 65. The electrochemical reaction device 2 and the thermal reactor 41 are connected by a gas flow path 67. The thermal reactor 41 and the vapor-liquid separator 42 are connected by a gas flow path 68 and a gas flow path 70. A circulation flow path 69 of a heat medium is provided between the thermal reactor 41 and the thermal exchanger 5. The CO₂ concentration unit 11 and the vapor-liquid separator 42 are connected by a gas flow path 71.

Each of the above-described flow paths is not limited in particular, and known pipes and the like can be used as appropriate. Air supply means such as compressors, valves, measurement equipment such as flowmeters, and the like can be installed at the gas flow paths 61, 67, 68, 70, and 71 as appropriate. Furthermore, liquid supply means such as pumps, valves, measurement equipment such as flowmeters, and the like can be installed at the liquid flow paths 62 to 66 as appropriate.

The capturing device 1 captures carbon dioxide. The CO₂ concentration unit 11 receives a supply of a gas G1 containing carbon dioxide of an atmosphere, an exhaust gas or the like. The CO₂ concentration unit 11 concentrates the carbon dioxide in the gas G1. As the CO₂ concentration unit 11, known concentration units can be adopted as long as these concentration units can concentrate carbon dioxide, and, for example, a membrane separator that uses a difference in a permeability speed for a membrane, or an adsorber/desorber that uses chemical or physical adsorption and desorption can be used. Adsorption that uses temperature swing adsorption in particular that is chemical adsorption is preferable from a standpoint of good separation performance.

A concentrated gas G2 obtained by concentrating the carbon dioxide by the CO₂ concentration unit 11 is supplied to the CO₂ absorption unit 12 through the gas flow path 61. Furthermore, a separated gas G3 separated from the concentrated gas G2 is supplied to the vapor-liquid separator 42 through the gas flow path 71.

In the CO₂ absorption unit 12, a carbon dioxide gas in the concentrated gas G2 supplied from the CO₂ concentration unit 11 contacts an electrolytic solution A, and the carbon dioxide is dissolved and absorbed in the electrolytic solution A. A method for bringing the carbon dioxide gas and the electrolytic solution A in contact with each other is not limited in particular, and can be exemplified as, for example, a method for blowing the concentrated gas G2 into the electrolytic solution A to bubble.

The CO₂ absorption unit 12 uses the electrolytic solution A that is a strongly alkaline aqueous solution as an absorbent for absorbing the carbon dioxide. Carbon atoms of the carbon dioxide are positively charged (5+) since oxygen atoms strongly attract electrons. Hence, in the strongly alkaline aqueous solution containing a great amount of hydroxide ions, the carbon dioxide readily develops a dissolution reaction from a hydration state to CO₃²⁻ via HCO₃⁻, and is in an equilibrium state where a ratio of CO₃²⁻ is high. In view of the above, the carbon dioxide readily dissolves in the strongly alkaline aqueous solution compared to other gasses such as nitrogen, hydrogen, and oxygen, and the carbon dioxide in the concentrated gas G2 is selectively absorbed in the electrolytic solution A in the CO₂ absorption unit 12. Consequently, by using the electrolytic solution A in the CO₂ absorption unit 12, it is possible to promote concentration of the carbon dioxide. Consequently, the CO₂ concentration unit 11 does not need to concentrate the carbon dioxide to a high concentration, so that it is possible to reduce energy necessary for concentration in the CO₂ concentration unit 11.

An electrolytic solution B in which the carbon dioxide has been absorbed by the CO₂ absorption unit 12 is fed to the electrochemical reaction device 2 through the liquid flow path 62, the electrical energy storage 32, the liquid flow path 63, the thermal exchanger 5, and the liquid flow path 64. Furthermore, the electrolytic solution A flowing out from the electrochemical reaction device 2 is fed to the CO₂ absorption unit 12 through the liquid flow path 65, the electrical energy storage 32, and the liquid flow path 66. Thus, the carbon dioxide treatment apparatus 100 circulates the electrolytic solutions between the CO₂ absorption unit 12, the electrical energy storage 32, and the electrochemical reaction device 2.

The strongly alkaline aqueous solution used for the electrolytic solution A can be exemplified as a potassium hydroxide aqueous solution and a sodium hydroxide aqueous solution. Among these aqueous solutions, the potassium hydroxide aqueous solution is preferably used from a viewpoint of good solubility of the carbon dioxide in the CO₂ absorption unit 12, and promotion of reduction of the carbon dioxide in the electrochemical reaction device 2.

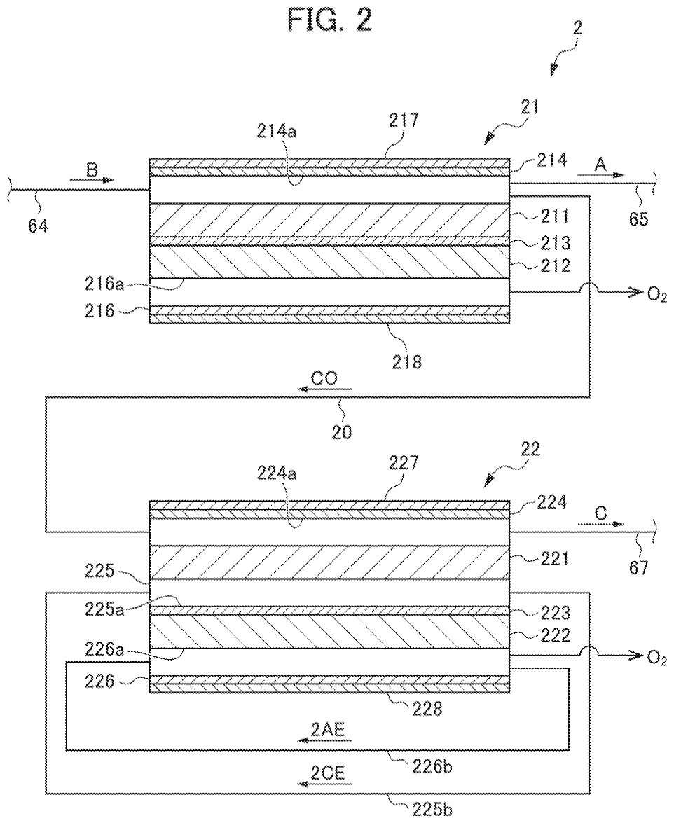

FIG. 2 is a schematic cross-sectional view illustrating an example of an electrolytic cell of the electrochemical reaction device 2. The electrochemical reaction device 2 includes a first electrolytic cell 21 and a second electrolytic cell 22 as an electrolytic cell. The electrochemical reaction device 2 uses these first electrolytic cell 21 and second electrolytic cell 22 to electrochemically reduce carbon dioxide. More specifically, a feature of the electrochemical reaction device 2 according to the present embodiment is that the electrochemical reaction device 2 separately executes two reduction reactions of a reduction reaction from carbon dioxide to carbon monoxide and a reduction reaction from the carbon monoxide to ethylene in a reaction path for obtaining the ethylene as a target product by the electrochemical reduction reaction of the carbon dioxide. Note that, although FIG. 2 illustrates the one electrolytic cell, the electrochemical reaction device 2 preferably includes an electrolytic cell stack including a stack of a plurality of the electrolytic cells each including the first electrolytic cell 21 and the second electrolytic cell 22.

As illustrated in FIG. 2, the first electrolytic cell 21 is disposed upstream of the second electrolytic cell 22 described later. The first electrolytic cell 21 includes a cathode 211, an anode 212, an anion exchange membrane 213, a cathode side liquid flow path structure 214 in which a cathode side liquid flow path 214a is formed, an anode side liquid flow path structure 216 in which an anode side liquid flow path 216a is formed, an electrical power feeder 217, and an electrical power feeder 218.

The electrical power feeder 217, the cathode side liquid flow path structure 214, the cathode 211, the anion exchange membrane 213, the anode 212, the anode side liquid flow path structure 216, and the electrical power feeder 218 are stacked in this order in the first electrolytic cell 21. Furthermore, the cathode side liquid flow path 214a is formed between the cathode 211 and the cathode side liquid flow path structure 214, and the anode side liquid flow path 216a is formed between the anode 212 and the anode side liquid flow path structure 216. These cathode side liquid flow path 214a and anode side liquid flow path 216a are provided at positions facing each other sandwiching the cathode 211, the anion exchange membrane 213, and the anode 212. Pluralities of these cathode side liquid flow paths 214a and anode side liquid flow paths 216a are preferably provided, and may have zigzag shapes in addition to linear shapes.

The electrical power feeder 217 and the electrical power feeder 218 are electrically connected with the electrical energy storage 32 of the electrical energy storage device 3. Furthermore, both of the cathode side liquid flow path structure 214 and the anode side liquid flow path structure 216 are conductors, and can apply a voltage between the cathode 211 and the anode 212 using electrical power supplied from the electrical energy storage 32.

The cathode 211 is an electrode that reduces carbon dioxide. More specifically, the cathode 211 of the first electrolytic cell 21 mainly reduces carbon dioxide to carbon monoxide. In this regard, part of the produced carbon monoxide may be reduced to ethylene.

The cathode 211 can be exemplified as, for example, an electrode that includes a gas diffusion layer, and a cathode catalyst layer that is formed on the cathode side liquid flow path 214a side of the gas diffusion layer. The cathode catalyst layer may be partially embedded and disposed in the gas diffusion layer. Furthermore, a porous layer that is finer than the gas diffusion layer may be disposed between the gas diffusion layer and the cathode catalyst layer.

As a cathode catalyst for forming the cathode catalyst layer, a known catalyst used for a reduction reaction of carbon dioxide can be used. Specific examples of the cathode catalyst can be exemplified as metals such as gold, silver, copper, platinum, palladium, nickel, cobalt, iron, manganese, titanium, cadmium, zinc, indium, gallium, lead, and tin, alloys and intermetallic compounds thereof, and metal complexes such as a ruthenium complex and a rhenium complex. Among these examples, preferred cathode catalysts for a reduction reaction from carbon dioxide to carbon monoxide are silver, gold, and zinc. One type of the cathode catalyst may be used alone, or two or more types of the cathode catalysts may be used in combination. As the cathode catalyst, a supported catalyst whose metal particles are supported by a carbon material (such as carbon particles, carbon nanotubes, or graphene) may be used.

The gas diffusion layer of the cathode 211 is not limited in particular, and can be exemplified as, for example, carbon paper or a carbon cloth. A method for manufacturing the cathode 211 is not limited in particular, and can be exemplified as a method for applying a slurry of a liquid composition containing the cathode catalyst to a face of the gas diffusion layer on the cathode side liquid flow path 214a side, and drying the face.

The anode 212 is an electrode that oxidizes hydroxide ions and produces oxygen. The anode 212 can be exemplified as, for example, an electrode that includes a gas diffusion layer, and an anode catalyst layer that is formed on the anode side liquid flow path 216a side of the gas diffusion layer. The anode catalyst layer may be partially embedded and disposed in the gas diffusion layer. Furthermore, a porous layer that is finer than the gas diffusion layer may be disposed between the gas diffusion layer and the anode catalyst layer.

An anode catalyst for forming the anode catalyst layer is not limited in particular, and a known anode catalyst can be used therefor. Specific examples of the anode catalyst can be exemplified as, for example, metals such as platinum, palladium, and nickel, alloys and intermetallic compounds thereof, metal oxides such as manganese oxide, iridium oxide, nickel oxide, cobalt oxide, iron oxide, tin oxide, indium oxide, ruthenium oxide, lithium oxide, and lanthanum oxide, and metal complexes such as a ruthenium complex and a rhenium complex. One type of the anode catalyst may be used alone, or two or more types of the anode catalysts may be used in combination.

The gas diffusion layer of the anode 212 can be exemplified as, for example, carbon paper or a carbon cloth. Furthermore, as the gas diffusion layer, porous bodies such as a mesh material, a punched material, a porous body, and a metal fiber sintered body may be used. A material of the porous body can be exemplified as, for example, metals such as titanium, nickel, or iron, and alloys (e.g., SUS) thereof.

Materials of the cathode side liquid flow path structure 214 and the anode side liquid flow path structure 216 can be exemplified as, for example, metals such as titanium and SUS, and carbon.

Materials of the electrical power feeder 217 and the electrical power feeder 218 can be exemplified as, for example, metals such as copper, gold, titanium and SUS, and carbon. As the electrical power feeder 217 and the electrical power feeder 218, electrical power feeders formed by applying plating processing such as gold plating to a surface of a copper substrate may be used.

Furthermore, as illustrated in FIG. 2, the second electrolytic cell 22 is disposed downstream of the first electrolytic cell 21. The second electrolytic cell 22 includes a cathode 221, an anode 222, an anion exchange membrane 223, a cathode side gas flow path structure 224 in which a cathode side gas flow path 224a is formed, a cathode side liquid flow path structure 225 in which a cathode side liquid flow path 225a is formed, an anode side liquid flow path structure 226 in which an anode side liquid flow path 226a is formed, an electrical power feeder 227, and an electrical power feeder 228.

The electrical power feeder 227, the cathode side gas flow path structure 224, the cathode 221, the cathode side liquid flow path structure 225, the anion exchange membrane 223, the anode 222, the anode side liquid flow path structure 226, and the electrical power feeder 228 are stacked in this order in the second electrolytic cell 22. Furthermore, the cathode side gas flow path 224a is formed between the cathode 221 and the cathode side gas flow path structure 224, the cathode side liquid flow path 225a is formed between the cathode 221 and the cathode side liquid flow path structure 225, and the anode side liquid flow path 226a is formed between the anode 222 and the anode side liquid flow path structure 226. These cathode side gas liquid flow path 224a, cathode side liquid flow path 225a, and anode side liquid flow path 226a are provided at positions facing each other sandwiching the cathode 221, the anion exchange membrane 223, and the anode 222. Pluralities of these cathode side gas flow paths 224a, cathode side liquid flow paths 225a, and anode side liquid flow paths 226a are preferably provided, and may have zigzag shapes in addition to linear shapes.

Furthermore, the second electrolytic cell 22 includes a cathode side electrolytic solution circulation path 225b that connects an inlet and an outlet of the cathode side liquid flow path 225a, and an anode side electrolytic solution circulation path 226b that connects an inlet and an outlet of the anode side liquid flow path 226a. The cathode side electrolytic solution circulation path 225b can circulate a cathode side electrolytic solution 2CE flowing in the cathode side liquid flow path 225a. Similarly, the anode side electrolytic solution circulation path 226b can circulate an anode side electrolytic solution 2AE flowing in the anode side liquid flow path 226a. Note that, as the cathode side electrolytic solution 2CE and the anode side electrolytic solution 2AE, the same strongly alkaline aqueous solutions as the above-described electrolytic solution A can be used.

The electrical power feeder 227 and the electrical power feeder 228 are electrically connected with the electrical energy storage 32 of the electrical energy storage device 3. Furthermore, all of the cathode side gas flow path structure 224, the cathode side liquid flow path structure 225, and the anode side liquid flow path structure 226 are conductors, and can apply a voltage between the cathode 221 and the anode 222 using electrical power supplied from the electrical energy storage 32.

The cathode 221 reduces a gas that is mainly carbon monoxide produced by reducing carbon dioxide in the first electrolytic cell 21 as described in detail below. More specifically, the cathode 221 of the second electrolytic cell 22 is an electrode that reduces carbon monoxide to ethylene. Furthermore, the cathode 211 can also reduce, to ethylene, unreacted carbon dioxide that has not been reduced to carbon monoxide in the first electrolytic cell 21.

The cathode 221 can be exemplified as, for example, an electrode that includes a gas diffusion layer, and a cathode catalyst layer that is formed on the cathode side liquid flow path 225a side of the gas diffusion layer. The cathode catalyst layer may be partially embedded and disposed in the gas diffusion layer. Furthermore, a porous layer that is finer than the gas diffusion layer may be disposed between the gas diffusion layer and the cathode catalyst layer.

As a cathode catalyst for forming the cathode catalyst layer, a known catalyst used for a reduction reaction of carbon dioxide can be used. Specific examples of the cathode catalyst can be exemplified as metals such as gold, silver, copper, platinum, palladium, nickel, cobalt, iron, manganese, titanium, cadmium, zinc, indium, gallium, lead, and tin, alloys and intermetallic compounds thereof, and metal complexes such as a ruthenium complex and a rhenium complex. Among these examples, a preferred cathode catalyst for a reduction reaction from carbon monoxide to ethylene is copper. One type of the cathode catalyst may be used alone, or two or more types of the cathode catalysts may be used in combination. As the cathode catalyst, a supported catalyst whose metal particles are supported by a carbon material (such as carbon particles, carbon nanotubes, or graphene) may be used.

The gas diffusion layer of the cathode 221 is not limited in particular, and can be exemplified as, for example, carbon paper or a carbon cloth. A method for manufacturing the cathode 221 is not limited in particular, and can be exemplified as a method for applying a slurry of a liquid composition containing the cathode catalyst to a face of the gas diffusion layer on the cathode side liquid flow path 225a side, and drying the face.

The anode 222 is an electrode that oxidizes hydroxide ions and produces oxygen. The anode 222 can be exemplified as, for example, an electrode that includes a gas diffusion layer, and an anode catalyst layer that is formed on the anode side liquid flow path 226a side of the gas diffusion layer. The anode catalyst layer may be partially embedded and disposed in the gas diffusion layer. Furthermore, a porous layer that is finer than the gas diffusion layer may be disposed between the gas diffusion layer and the anode catalyst layer.

An anode catalyst for forming the anode catalyst layer is not limited in particular, and a known anode catalyst can be used therefor. Specific examples of the anode catalyst can be exemplified as, for example, metals such as platinum, palladium, and nickel, alloys and intermetallic compounds thereof, metal oxides such as manganese oxide, iridium oxide, nickel oxide, cobalt oxide, iron oxide, tin oxide, indium oxide, ruthenium oxide, lithium oxide, and lanthanum oxide, and metal complexes such as a ruthenium complex and a rhenium complex. One type of the anode catalyst may be used alone, or two or more types of the anode catalysts may be used in combination.

The gas diffusion layer of the anode 222 can be exemplified as, for example, carbon paper or a carbon cloth. Furthermore, as the gas diffusion layer, porous bodies such as a mesh material, a punched material, a porous body, and a metal fiber sintered body may be used. A material of the porous body can be exemplified as, for example, metals such as titanium, nickel, or iron, and alloys (e.g., SUS) thereof.

Materials of the cathode side gas flow path structure 224, the cathode side liquid flow path structure 225, and the anode side liquid flow path structure 216 can be exemplified as, for example, metals such as titanium and SUS, and carbon.

Materials of the electrical power feeder 227 and the electrical power feeder 228 can be exemplified as, for example, metals such as copper, gold, titanium, and SUS, and carbon. As the electrical power feeder 227 and the electrical power feeder 228, electrical power feeders formed by applying plating processing such as gold plating to a surface of a copper substrate may be used.

The reduction reactions of carbon dioxide in the above-described first electrolytic cell 21 and the second electrolytic cell 22 will be described in more detail below.

The first electrolytic cell 21 employing the above-described configuration is a flow cell in which the electrolytic solution B supplied from the CO₂ absorption unit 12 and fed via the electrical energy storage 32 and the thermal exchanger 5 flows in the cathode side liquid flow path 214a. When a voltage is applied to the cathode 211 and the anode 212, dissolved carbon dioxide in the electrolytic solution B flowing in the cathode side liquid flow path 214a is electrochemically reduced. The electrolytic solution B at the inlet of the cathode side liquid flow path 214a is in a weakly alkaline state where a ratio of CO₃²⁻ is high since the carbon dioxide is dissolved. On the other hand, as the electrolytic solution flows in the cathode side liquid flow path 214a and reduction proceeds, a dissolved carbon dioxide amount, i.e., a CO₃²⁻ amount in the electrolytic solution lowers, and therefore the electrolytic solution B becomes the electrolytic solution A in the strongly alkaline state at the outlet of the cathode side liquid flow path 214a. The electrolytic solution A flowing out from the outlet of the cathode side liquid flow path 214a is fed to the electrical energy storage 32 described below.

The electrolytic solution B is under weak alkali at the cathode 211 of the first electrolytic cell 21 as described above, and therefore a product produced by reduction of carbon dioxide is mainly carbon monoxide. More specifically, when a reaction represented by a following cathode half chemical reaction proceeds, the cathode 211 produces the carbon monoxide as a gaseous product. The produced gaseous carbon monoxide flows out from the outlet of the cathode side liquid flow path 214a.

2CO₃²⁻+4H₂O→2CO+8OH⁻ [Cathode Half Chemical Equation]

The hydroxide ions produced at the cathode 211 of the first electrolytic cell 21 permeates the anion exchange membrane 213, move to the anode 212, are oxidized by a reaction represented by a following anode half chemical equation, and produce oxygen. The produced oxygen permeates the gas diffusion layer of the anode 212, flows in the anode side liquid flow path 216a, and flows out from the outlet of the anode side liquid flow path 216a.

8OH⁻−O₂+2H₂O+4OH⁻ [Anode Half Chemical Equation]

Hence, a reaction represented by a following full chemical equation proceeds in the first electrolytic cell 21 as a whole.

2CO₃²⁻+2H₂O→2CO+O₂+4OH⁻ [Full Chemical Equation]

Thus, the carbon dioxide treatment apparatus 100 according to the present embodiment shares the electrolytic solution used for the electrochemical reaction device 2 as the absorbent of the CO₂ absorption unit 12, and supplies carbon dioxide with the electrolytic solution B dissolved therein to the electrochemical reaction device 2 to electrochemically reduce. Consequently, compared to a case where, for example, carbon dioxide is adsorbed to an adsorbent, heated and thereby desorbed, and reduced, it is possible to reduce energy required for desorption of carbon dioxide and increase energy efficiency.

In this regard, as described above, the electrolytic solution B at the inlet of the cathode side liquid flow path 214a is in a weakly alkaline state where the ratio of CO₃²⁻ is high since the carbon dioxide is dissolved therein. By contrast with this, the carbon dioxide reduction reaction has a problem that the reduction reaction hardly proceeds under weak alkali, and therefore generation efficiency of ethylene of interest is poor. Hence, as described above, a gas flowing out from the outlet of the cathode side liquid flow path 214a of the first electrolytic cell 21 is mainly carbon monoxide.

By contrast with this, the electrochemical reaction device 2 according to the present embodiment includes a carbon monoxide supply path 20 that supplies to the cathode side gas flow path 224a of the second electrolytic cell 22 a gas that is mainly carbon monoxide flowing out from the outlet of the cathode side liquid flow path 214a of the first electrolytic cell 21. The carbon monoxide supply path 20 is provided to connect the outlet of the cathode side liquid flow path 214a of the first electrolytic cell 21, and the inlet of the cathode side gas flow path 224a of the second electrolytic cell 22.

The second electrolytic cell 22 is a flow cell in which the carbon monoxide supplied from the first electrolytic cell 21 through the carbon monoxide supply path 20 flows in the cathode side gas flow path 224a. When a voltage is applied to the cathode 221 and the anode 222, carbon monoxide flowing in the cathode side gas flow path 224a is electrochemically reduced, and ethylene is produced.

More specifically, when a reaction represented by a following cathode half chemical reaction proceeds, the cathode 221 of the second electrolytic cell 22 produces the ethylene as a gaseous product. The carbon monoxide supplied from the first electrolytic cell 21 through the carbon monoxide supply path 20 does not dissolve in the electrolytic solution, and the electrolytic solution does not become weakly alkaline. Consequently, the carbon monoxide reduction reaction efficiently proceeds at the cathode 221 of the second electrolytic cell 22, and, as a result, ethylene is efficiently produced.

2CO+4H₂O→C₂H₄+4OH⁻ [Cathode Half Chemical Equation]

The hydroxide ions produced at the cathode 221 of the second electrolytic cell 22 permeates the anion exchange membrane 223, move to the anode 222, are oxidized by a reaction represented by a following anode half chemical equation, and produce oxygen. The produced oxygen permeates the gas diffusion layer of the anode 222, flows in the anode side liquid flow path 226a, and flows out from the outlet of the anode side liquid flow path 226a.

4OH⁻−O₂+2H₂O [Anode Half Chemical Equation]

Hence, a reaction represented by a following full chemical equation proceeds in the second electrolytic cell 22 as a whole.

2CO+2H₂O→C₂H₄+2O₂ [Full Chemical Equation]

As described above, according to the present embodiment, the first electrolytic cell 21 electrochemically reduces carbon dioxide to carbon monoxide, and then the second electrolytic cell 22 electrochemically reduces the carbon monoxide produced by the first electrolytic cell 21 to ethylene. That is, the first electrolytic cell 21 in which the carbon dioxide to be supplied dissolves and the electrolytic solution becomes weakly alkaline intentionally produces the carbon monoxide. Furthermore, the carbon monoxide does not dissolve in the electrolytic solution, the electrolyte does not become weakly alkaline, and therefore the carbon monoxide produced by the first electrolytic cell 21 is supplied to the second electrolytic cell 22. Consequently, it is possible to promote the electrochemical reduction reaction of the carbon monoxide while preventing the electrolytic solution from becoming weakly alkaline in the second electrolytic cell 22, so that it is possible to selectively and efficiently produce ethylene in the present embodiment.

Back to FIG. 1, the electrical energy storage device 3 is a device that supplies electrical power to the electrochemical reaction device 2. The converter 31 convers renewable energy into electrical energy. The converter 31 is not limited in particular, and can be exemplified as, for example, a wind power generator, a solar power generator, a geothermal power generator, and the like. There may be provided one or a plurality of the converters 31 included in the electrical energy storage device 3.

The electrical energy storage 32 is electrically connected with the converter 31. The electrical energy storage 32 stores the electrical energy converted by the converter 31. The electrical energy storage 32 stores the converted electrical energy, so that it is possible to stably supply electrical power to the electrochemical reaction device 2 even when the converter 31 does not generate power. Furthermore, although a voltage generally fluctuates significantly in a case where renewable energy is used, the electrical energy storage 32 stores the renewable energy once, so that it is possible to supply electrical power at a stable voltage to the electrochemical reaction device 2.

The electrical energy storage 32 according to the present embodiment is configured as a nickel-metal hydride battery. In this regard, the electrical energy storage 32 only needs to be configured to enable charging and discharging, and may be configured as, for example, a lithium secondary battery or the like.

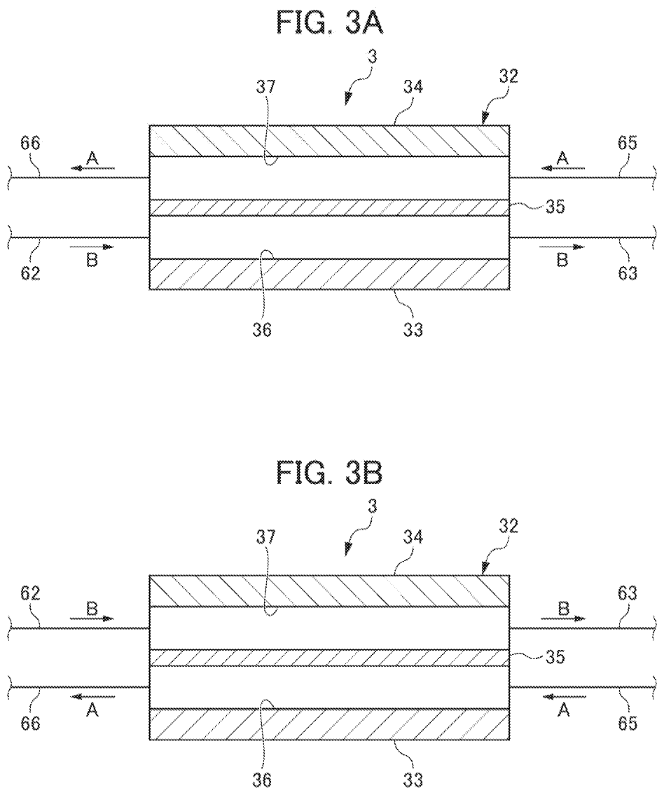

Here, FIG. 3A is a view illustrating a nickel-metal hydride battery of the electrical energy storage 32 at a time of discharging. FIG. 3B is a view illustrating a nickel-metal hydride battery of the electrical energy storage 32 at a time of charging. As illustrated in these FIGS. 3A and 3B, the electrical energy storage 32 is a nickel-metal hydride battery that includes a positive electrode 33, a negative electrode 34, a separator 35 that is provided between the positive electrode 33 and the negative electrode 34, a positive electrode side flow path 36 that is formed between the positive electrode 33 and the separator 35, and a negative electrode side flow path 37 that is formed between the negative electrode 34 and the separator 35. The positive electrode side flow path 36 and the negative electrode side flow path 37 can be formed by using, for example, the same liquid flow path structures as the cathode side liquid flow path and the anode side liquid flow path of the electrochemical reaction device 2.

The positive electrode 33 can be exemplified as, for example, a positive electrode obtained by applying a positive electrode active material to the positive electrode side flow path 36 side of a positive electrode current capturing device. The positive electrode current capturing device is not limited in particular, and can be exemplified as, for example, a nickel foil or a nickel plating metal foil. The positive electrode active material is not limited in particular, and can be exemplified as, for example, nickel hydroxide or nickel oxyhydroxide.

The negative electrode 34 can be exemplified as, for example, a negative electrode obtained by applying a negative electrode active material to the negative electrode side flow path 37 side of a negative electrode current capturing device. The negative electrode current capturing device is not limited in particular, and can be exemplified as, for example, a nickel mesh. The negative electrode active material is not limited in particular, and can be exemplified as, for example, a known hydrogen absorbing alloy.

The separator 35 is not limited in particular, and can be exemplified as, for example, an ion exchange membrane.

The nickel-metal hydride battery of the electrical energy storage 32 is a flow cell in which the electrolytic solution flows to each of the positive electrode side flow path 36 of the separator 35 on the positive electrode 33 side, and the negative electrode side flow path 37 of the separator 35 on the negative electrode 34 side. The carbon dioxide treatment apparatus 100 according to the present embodiment supplies the electrolytic solution B supplied from the CO₂ absorption unit 12 through the liquid flow path 62, and the electrolytic solution A supplied from the electrochemical reaction device 2 through the liquid flow path 65 to each of the positive electrode side flow path 36 and the negative electrode side flow path 37.

Furthermore, connection of the liquid flow path 62 and the liquid flow path 63 to the electrical energy storage 32 can be switched by, for example, a changeover valve or the like between a state where the liquid flow path 62 and the liquid flow path 63 are connected to the positive electrode side flow path 36 and a state where the liquid flow path 62 and the liquid flow path 63 are connected to the negative electrode side flow path 37. Similarly, connection of the liquid flow path 65 and the liquid flow path 66 to the electrical energy storage 32 can be switched by, for example, a changeover valve or the like between a state where the liquid flow path 65 and the liquid flow path 66 are connected to the positive electrode side flow path 36 and a state where the liquid flow path 65 and the liquid flow path 66 are connected to the negative electrode side flow path 37.

When the nickel-metal hydride battery discharges, hydroxide ions are produced from water molecules at the positive electrode 33, the hydroxide ions having moved to the negative electrode 34 accept hydrogen ions from the hydrogen absorbing alloy, and the water molecules are produced. Hence, from a viewpoint of discharging efficiency, a weakly alkaline state of the electrolytic solution flowing in the positive electrode side flow path 36 is advantageous, and a strongly alkaline state of the electrolytic solution flowing in the negative electrode side flow path 37 is advantageous. Hence, as illustrated in FIG. 3A, at a time of discharging, the liquid flow path 62 and the liquid flow path 63 are connected to the positive electrode side flow path 36, the liquid flow path 65 and the liquid flow path 66 are connected to the negative electrode side flow path 37, the electrolytic solution B of the weakly alkaline state supplied from the CO₂ absorption unit 12 flows in the positive electrode side flow path 36, and the electrolytic solution A of the strongly alkaline state supplied from the electrochemical reaction device 2 flows in the negative electrode side flow path 37. That is, at the time of discharging, the electrolytic solution is preferably circulated in order of the CO₂ absorption unit 12, the positive electrode side flow path 36 of the electrical energy storage 32, the electrochemical reaction device 2, the negative electrode side flow path 37 of the electrical energy storage 32, and the CO₂ absorption unit 12.

Furthermore, when the nickel-metal hydride battery charges, water molecules are produced from hydroxide ions at the positive electrode 33, the water molecules are decomposed into the hydrogen atoms and the hydroxide ions at the negative electrode 34, and the hydrogen atoms are absorbed by the hydrogen absorbing alloy. Hence, from a viewpoint of charging efficiency, a strongly alkaline state of the electrolytic solution flowing in the positive electrode side flow path 36 is advantageous, and a weakly alkaline state of the electrolytic solution flowing in the negative electrode side flow path 37 is advantageous. Hence, as illustrated in FIG. 3B, at a time of charging, the liquid flow path 62 and the liquid flow path 63 are connected to the negative electrode side flow path 37, the liquid flow path 65 and the liquid flow path 66 are connected to the positive electrode side flow path 36, the electrolytic solution B of the weakly alkaline state supplied from the CO₂ absorption unit 12 flows in the negative electrode side flow path 37, and the electrolytic solution A of the strongly alkaline state supplied from the electrochemical reaction device 2 flows in the positive electrode side flow path 36. That is, at the time of charging, the electrolytic solution is preferably circulated in order of the CO₂ absorption unit 12, the negative electrode side flow path 37 of the electrical energy storage 32, the electrochemical reaction device 2, the positive electrode side flow path 36 of the electrical energy storage 32, and the CO₂ absorption unit 12.

Generally, when a secondary battery is incorporated in a device, total energy efficiency corresponding to charging/discharging efficiency tends to lower. However, according to the present embodiment, by using pH gradients of the electrolytic solution A and the electrolytic solution B before and after the electrochemical reaction device 2 as described above, and appropriately replacing the electrolytic solutions to flow in the positive electrode side flow path 36 and the negative electrode side flow path 37 of the electrical energy storage 32, it is possible to improve charging/discharging efficiency corresponding to a “concentration overpotential” of an electrode reaction represented by an equation of Nernst.

Back to FIG. 1, the homologation reaction device 4 is a device that polymerizes and homologates ethylene produced by reducing carbon dioxide by the electrochemical reaction device 2. An ethylene gas C produced by the reduction in the electrochemical reaction device 2 is fed to the thermal reactor 41 through the gas flow path 67. The thermal reactor 41 performs an ethylene polymerization reaction under presence of an olefin polymerization catalyst. Consequently, it is possible to produce homologated olefin such as 1-butene, 1-hexane, and 1-octene.

The olefin polymerization catalyst is not limited in particular, a known catalyst used for a polymerization reaction can be used therefor, and the olefin polymerization catalyst can be exemplified as, for example, a solid acid catalyst and a transition metal complex compound that use silica alumna or zeolite for carriers.

The homologation reaction device 4 according to the present embodiment feeds a produced gas D subjected to the polymerization reaction and flowing out from the thermal reactor 41 to the vapor-liquid separator 42 through the gas flow path 68. Olefin having six or more carbons is a liquid at a normal temperature. Hence, in a case where, for example, olefin having six or more carbons is a target carbon compound, it is possible to easily perform vapor-liquid separation on the olefin (olefin solution E1) having six or more carbons and olefin (olefin gas E2) having less than six carbons by setting a temperature of the vapor-liquid separator 42 to approximately 30° C. Furthermore, it is possible to increase the number of carbons of the resulting olefin solution E1 by increasing the temperature of the vapor-liquid separator 42.

In a case where the gas G1 supplied to the CO₂ concentration unit 11 of the capturing device 1 is an atmosphere, the separated gas G3 fed from the CO₂ concentration unit 11 through the gas flow path 71 may be used to cool the produced gas D in the vapor-liquid separator 42. For example, the vapor-liquid separator 42 including a cooling pipe is used, and the separated gas G3 is caused to flow in the cooling pipe, and is condensed on a surface of the cooling pipe by causing the produced gas D to flow outside the cooling pipe to obtain the olefin solution E1. Furthermore, the olefin gas E2 separated by the vapor-liquid separator 42 contains olefin that has a smaller number of carbons than that of an unreacted component such as ethylene or the olefin of interest, and therefore can be returned to the thermal reactor 41 through the gas flow path 70 and reused for a polymerization reaction.

The ethylene polymerization reaction in the thermal reactor 41 is an exothermic reaction where a supplied substance has higher enthalpy than that of a produced substance, and reaction enthalpy becomes negative. The carbon dioxide treatment apparatus 100 heats a heat medium F by using reaction heat generated by the thermal reactor 41 of the homologation reaction device 4, circulates the heat medium F to the thermal exchanger 5 through the circulation flow path 69, and causes the heat medium F and the electrolytic solution B to exchange heat in the thermal exchanger 5. Thus, the electrolytic solution B supplied to the electrochemical reaction device 2 is heated. In the electrolytic solution B that uses the strongly alkaline aqueous solution, the dissolved carbon dioxide is hardly separated as a gas even when a temperature is raised, and the rise in the temperature of the electrolytic solution B improves a reaction rate of oxidation-reduction in the electrochemical reaction device 2.

The homologation reaction device 4 may include a reactor that performs a hydrogenation reaction of olefin obtained by polymerizing ethylene using hydrogen produced by the electrochemical reaction device 2, or a reactor that performs an isomerization reaction of olefin or paraffin.

### [Carbon Dioxide Treatment Method]

A carbon dioxide treatment method according to the embodiment of the present invention is executed by using, for example, the above-described carbon dioxide treatment apparatus 100. More specifically, the carbon dioxide treatment method according to the present embodiment preferably includes a step (a) of bringing a carbon dioxide gas in contact with an electrolytic solution that is a strongly alkaline aqueous solution, dissolving carbon dioxide in the electrolytic solution, and causing the electrolytic solution to absorb the carbon dioxide, and a step (b) of electrochemically reducing the dissolved carbon dioxide in the electrolytic solution. The carbon dioxide treatment method according to the present embodiment can be used for an ethylene producing method.

Furthermore, a feature of the carbon dioxide treatment method according to the present embodiment is that an electrochemical reduction step of the carbon dioxide as in the above step (b) includes a first step of electrochemically reducing the carbon dioxide to carbon monoxide by the first electrolytic cell 21, and a second step of electrochemically reducing the carbon monoxide produced in the first step to ethylene by the second electrolytic cell 22. Thus, the first electrolytic cell 21 in which the carbon dioxide to be supplied dissolves and the electrolytic solution becomes weakly alkaline supplies the carbon monoxide produced by the first electrolytic cell 21 to the second electrolytic cell to intentionally produce the carbon monoxide. The carbon monoxide does not dissolve in the electrolytic solution, and the electrolytic solution does not become weakly alkaline, so that it is possible to promote the electrochemical reduction reaction of the carbon monoxide while preventing the electrolytic solution from becoming weakly alkaline in the second electrolytic cell 22, and it is possible to selectively and efficiently generate ethylene.

Furthermore, the carbon dioxide treatment method according to the present embodiment preferably further includes a step (c) of polymerizing ethylene produced by reducing the carbon dioxide in addition to the step (a) and the step (b) as in a case where a carbon dioxide treatment apparatus including the homologation reaction device 4 similar to the above-described carbon dioxide treatment apparatus 100 is used.

Note that the present invention is not limited to the above embodiment, and variations and improvements within a range that can achieve the object of the present invention are incorporated in the present invention.

The above embodiment employs the configuration where the carbon dioxide is dissolved in the electrolytic solution and is supplied to the electrochemical reaction device 2, yet is not limited to this. There may be employed a configuration where the carbon dioxide gas is supplied as is to the electrochemical reaction device 2. In this case, there may be employed a configuration where, for example, a cathode side gas flow path is provided to the first electrolytic cell 21 of the electrochemical reaction device 2, and a carbon dioxide gas is supplied to the cathode side gas flow path. Even in this case, the carbon dioxide gas flows in the electrolytic solution flowing in the cathode side liquid flow path, the electrolytic solution becomes weakly alkaline, and therefore it is significant to apply the present invention.

Note that, when the carbon dioxide gas is supplied as is to the electrochemical reaction device 2, a chemical equation indicated below proceeds in the first electrolytic cell. A reaction that proceeds in the second electrolytic cell is the same as that of the above embodiment.

2CO₂+2H₂O→2CO+4OH⁻ [Cathode Half Chemical Reaction]

4OH⁻→O₂+2H₂O [Anode Half Chemical Reaction]

2CO₂+2H₂O→2CO+O₂ [Full Chemical Reaction]

Furthermore, according to the above embodiment, the carbon dioxide treatment apparatus 100 employs the configuration including the capturing device 1, the electrical energy storage device 3, the homologation reaction device 4, and the thermal exchanger 5, yet is not limited to this, and may employ a configuration that does not include all or part of these units.

### EXPLANATION OF REFERENCE NUMERALS

1 capturing device
2 electrochemical reaction unit (electrochemical reaction device)
4 homologation reaction device
12 CO₂ absorption unit
20 carbon monoxide supply path
21 first electrolytic cell
22 second electrolytic cell
211, 221 cathode
212, 222 anode
213, 223 anion exchange membrane (electrolytic membrane)
214a, 225a cathode side liquid flow path
216a, 226a anode side liquid flow path
224a cathode side gas flow path
100 carbon dioxide treatment apparatus

What is claimed is:

1. A carbon dioxide treatment apparatus comprising:
a capturing device that captures carbon dioxide; and
an electrochemical reaction device that electrochemically reduces the carbon dioxide captured by the capturing device,
the electrochemical reaction device including:
a first electrolytic cell that electrochemically reduces the carbon dioxide to carbon monoxide; and
a second electrolytic cell that electrochemically reduces the carbon monoxide produced by the first electrolytic cell to ethylene.

2. The carbon dioxide treatment apparatus according to claim 1,
further including a carbon monoxide supply path that is provided between the first electrolytic cell and the second electrolytic cell, and supplies the carbon monoxide produced by the first electrolytic cell to the second electrolytic cell.

3. The carbon dioxide treatment apparatus according to claim 2, further including a carbon dioxide absorption unit that dissolves and absorbs the carbon dioxide in a strongly alkaline electrolytic solution, and
the carbon dioxide dissolved in the electrolytic solution by the carbon dioxide absorption unit is supplied to the electrochemical reaction device.

4. The carbon dioxide treatment apparatus according to claim 3, wherein the first electrolytic cell includes:
a cathode;
an anode;
an electrolytic membrane that is provided between the cathode and the anode;
a cathode side liquid flow path that is provided adjacent to the cathode, and in which the electrolytic solution with the carbon dioxide dissolved therein flows; and
an anode side liquid flow path that is provided adjacent to the anode and in which the electrolytic solution flows,
wherein the second electrolytic cell includes:
a cathode;
an anode;
an electrolytic membrane that is provided between the cathode and the anode;
a cathode side gas flow path that is provided adjacent to the cathode, and in which a gas flows; and
a cathode side liquid flow path that is provided adjacent to the cathode, and in which the electrolytic solution flows;
an anode side liquid flow path that is provided adjacent to the anode, and in which the electrolytic solution flows, and
wherein the carbon monoxide supply path is provided to connect an outlet of the cathode side liquid flow path of the first electrolytic cell, and an inlet of the cathode side gas flow path of the second electrolytic cell.

5. The carbon dioxide treatment apparatus according to claim 1, further comprising a homologation reaction device that multimerizes and homologates the ethylene produced by reducing the carbon dioxide by the electrochemical reaction device.

6. A carbon dioxide treatment method of electrochemically reducing carbon dioxide, comprising:
a first step of electrochemically reducing carbon dioxide to carbon monoxide by a first electrolytic cell; and
a second step of electrochemically reducing the carbon monoxide produced in the first step to ethylene by a second electrolytic cell.

7. An ethylene producing method, including reducing carbon dioxide and producing ethylene by the carbon dioxide treatment method according to claim 6.
